(19) United States
(12) Patent Application Publication
(10) Pub. No.: US 2005/0094103 A1
(43) Pub. Date: May 5, 2005

(54) Real image projection system for gaming, ATM, vending machines, merchandising displays and related applications

(75) Inventors: Douglas L. Robinson, Ithaca, NY (US); Kenneth S. Westort, Ithaca, NY (US)

Correspondence Address: BROWN & MICHAELS, PC;400 M & T BANK BUILDING, 118 NORTH TIOGA ST, ITHACA, NY, 14850, US

(73) Assignee: Optical Products Development Corporation, Elmira, NY (US)

(21) Appl. No.: 10/949,664

(22) Filed: Sep. 24, 2004

Related U.S. Application Data
(63) Continuation-in-part of application No. 10/177,873, filed on Jun. 21, 2002, now abandoned.
Application No. 10/177,873 is a continuation-in-part of application No. 09/933,331, filed on Aug. 20, 2001, now Pat. No. 6,612,701.
Application No. 10/177,873 is a continuation-in-part of application No. 09/946,183, filed on Sep. 5, 2001, now Pat. No. 6,598,976.
Application No. 10/177,873 is a continuation-in-part of application No. 10/126,167, filed on Apr. 19, 2002, now Pat. No. 6,733,140.
(63) Continuation-in-part of application No. PCT/US03/11017, filed on Apr. 11, 2003.
(60) Provisional application No. 60/458,811, filed on Mar. 28, 2003.

(51) Int. Cl. G03B 21/00

(52) U.S. Cl. 353/10

(57) ABSTRACT

An improved real image projection device includes a real image projection system for projecting a real image from one or more sources that transmit, reflect or emit light, operatively connected with a slot machine, gaming machine, an ATM machine, vending machine or other like machines, enhancing the functionality and experience in slot or gaming machines, ATM machines, vending machines, point of purchase merchandising displays, and the like. One embodiment includes an e-mail capture system that includes a computer, microprocessor device, memory, or other device for storing an e-mail database, and a keyboard, touch-screen device, or pointing device and display monitor, or other input device, arranged for a viewer of the real image to enter one or more e-mail addresses into the database.

### BACKGROUND OF THE INVENTION

1. Field of the Invention

The invention pertains to the field of real image projection systems. More particularly, the invention pertains to the use of a real image projection system to enhance the functionality and experience in slot or gaming machines, ATM machines, vending machines, merchandising displays, and the like, and/or including a system for capturing viewers' e-mail addresses.

2. Description of Related Art

The present invention pertains to a real image projection system and, in particular, to such a system in which a real image of a three-dimensional object or a two-dimensional source, such as, for example, a photograph or computer screen, is formed in space, giving the illusion that a real object exists at that point in space, when in reality it does not.

Visual display systems are well known in the art and typically use a curved reflector with a beamsplitter positioned at a 45 degree angle to the curved reflector's optical axis to divert the input beam path at a 90 degree angle to the viewing axis or imaging beam path. This method has been used since the early 1950s for flight simulation, and commonly is referred to as the WAC window system. These systems typically are used in an on-axis configuration, meaning that the optical axis, or the un-tilted curved reflector's center of radius, is located along the viewing axis. When viewing such an on-axis system, any object within the viewing area images within the system.

One of the earliest working real image displays is depicted in White's 1934 publication of “Fundamentals of Optics”. It shows a spherical mirror positioned behind a table. A flower vase is mounted below the table and a real image of the vase is projected sitting on the table-top. In the late 1980's, real image display systems were further developed, typically consisting of two on-axis parabolic reflector segments, as described in U.S. Pat. No. 4,802,750. In the early 1990's, similar systems were built that use a beamsplitter having high reflection and low transmission, in order to reduce ghosting effects. By 1999, a system was developed using a circularly-polarized window in an on-axis, WAC window-style configuration. For example, U.S. Pat. No. 6,163,408 was issued in 2000. Later, a tilted system was developed, using an off-axis, curved reflector, as disclosed in International Patent Application No. PCT/US00/11234 and PCT Publication No. WO 00/65844. That system comprises a curved reflector tilted at an angle between 5 and 20 degrees from the viewing axis. A beamsplitter is positioned along the viewing axis, tilted at 45 degrees to the curved reflector's axis. With the development of such high-transmission real imaging systems, many new enhancements are possible.

### SUMMARY OF THE INVENTION

The invention provides an improved real image projection device comprising a real image projection system for projecting a real image, wherein said real image projection system is operatively connected with a slot machine, gaming machine, an ATM machine, vending machine or other like machines. The real image projection system preferably uses a video image source, such as, for example, a monitor, as the image source (although any type of image source optionally can be used), and the video signal source preferably is controlled or influenced by the activity of the host machine (i.e., slot, ATM, etc.). However, the system also is well suited to imaging real objects, which optionally are mounted on a turntable, such as, for example, dice or perfume sampler bottles that can be rotated on the turntable.

The invention further provides a real image projection system incorporating an e-mail capture system, and is referred to generally as an e-mail register kiosk. In one embodiment, an improved real image projection device comprises a real image projection system for projecting a real image, and an e-mail capture system for establishing a database of e-mail addresses entered by viewers of said real image.

In another embodiment, an improved real image projection device comprises a real image projection system for projecting a real image, and an e-mail capture system comprising a computer, microprocessor device, memory, or other means for storing said database, and a keyboard, touch-screen device, or pointing device and display monitor, or other input means, arranged for a viewer of said real image to enter one or more e-mail addresses into said database. As a viewer approaches the floating real image produced by the real image projection system, the input device is provided, preferably a touch-screen display (e.g., optionally located under the real image window), wherein an image of a keyboard is displayed to the viewer. The touch-screen display optionally displays advertising and/or prompts the viewer to enter the viewer's e-mail address to receive various free promotional items.

The real image projection system preferably includes an aspheric mirror configuration (as described in U.S. Pat. No. 6,612,701, the complete disclosure of which is hereby incorporated herein by reference in its entirety), or a tilted optical system designed for high brightness and low ghost reflections (as described in U.S. Pub. Nos. US 2003-0147145 A1, US 2003-0197839 A1, US 2003-0210380 A1, the complete disclosures of which are hereby incorporated herein by reference in their entireties). Using aspheric optics can significantly improve image quality, particularly when the system is used in an off-axis arrangement. The system optionally also is used with a circular polarizing window or beamsplitter configuration (as described in U.S. Pat. No. 6,163,408, the complete disclosure of which is hereby incorporated herein by reference in its entirety).

### BRIEF DESCRIPTION OF THE DRAWING

FIG. 1 shows a slot machine with a real image projection system mounted to the top of the machine.

FIG. 2 shows a side view of the slot machine of FIG. 1 and the viewing area of the real image.

FIG. 3 shows an example of a typical dual aspheric real image display chassis with a dice as the image source, rotation mechanism, and the internal lighting for said image source.

FIG. 4 shows an example of a typical dual aspheric real image display chassis with a monitor as the image source.

FIG. 5 shows an example of an ATM machine with a real image projection system incorporating a video background as a primary transaction screen.

FIG. 6 shows a top-box application of an ATM machine wherein the real image is separate from the transactional screen.

FIG. 7 shows a merchandising display application whereby perfume samplers are promoted using a real image projection system mounted into the display as an attractor.

FIG. 8 shows a vending machine application wherein the real image projection system is incorporated into the structure to either enhance the operation and function of the machine or as an attractor.

FIG. 9 shows two infrared controlled MPEG decoder devices as commercially available and a custom dual output Infrared transmitter designed to be controlled by a main CPU, through use of an intermediary micro-controller chip.

FIG. 11 shows an embodiment of the e-mail register kiosk of the present invention including a real image projection system.

FIG. 12 shows an embodiment of the e-mail register kiosk including a real image projection system utilizing two curved reflectors.

FIG. 13 shows an embodiment of the e-mail register kiosk including a real image projection system utilizing a tilted reflector optical system.

FIG. 14 shows an embodiment of the e-mail register kiosk including a tilted optic real image projection system.

FIG. 15 shows a photo-screen for use with the e-mail register kiosk of the present invention, comprising a transparent or semi-transparent material having a fixed or static image applied to the surface thereof. In an embodiment of the invention, the photo-screen is positioned so as to intersect a real image beampath of the real image projection device.

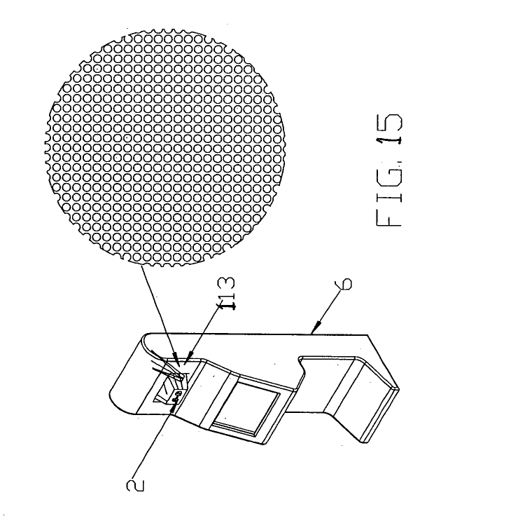

### DETAILED DESCRIPTION OF THE INVENTION

The present invention pertains to a real image projection system and, in particular, to such a system in which a real image of a three-dimensional object or a two-dimensional source, such as, for example, a photograph or computer screen, is formed in space, giving the illusion that a real object exists at that point in space, when in reality it does not. More particularly, the invention pertains to the use of a real image projection system to enhance the functionality and experience in slot or gaming machines, ATM machines, vending machines, merchandising displays, and the like.

For example, in a slot machine embodiment, the video content preferably is of a subject that compliments or relates to the game play theme or content. As an example of a slot machine embodiment, the real image projection system would project 3D images of coins tumbling with a floating “Winner” image pulsing out in front of the player, when the slot machine lands on three sevens. In the case of networked banks of gaming machines, the real image would float out in front of an individual machine as the machine became “hot” or odds were at the highest for that machine, thus the real image becomes an integral part of the game play experience. An alternative embodiment would include a real image display using a series of two or three dice as a source that would rotate and optionally independently controlled to stop at predetermined numbers. The image optionally is a spinning wheel with numbers. This optionally could be used as a bonus spin or bonus multiplier for jackpots.

In another embodiment, the real image projection system is integrated with an ATM machine. The real image source preferably is a video monitor, LCD, or CRT (but can be any image source, including a real object, such as a credit card on a rotating spindle). The video signal preferably is supplied by a computer, digital media player, or from the ATM electronics. The real image projection system optionally is activated by an infrared sensor or proximity sensor to determine when a person is within range of a unit. In such an optional configuration, when a person passes the ATM, the system will then project an image or play advertising content, for example, in 3D floating out over the ATM unit. The system also optionally runs advertising for bank financing, credit cards, and banking services, as well as general advertising. When the real image projection system uses a background video screen behind the floating image, video advertisements can be run on the background that relate to the real image. The background video image can also incorporate the ATM transaction screen, while the real image simultaneously interacts with the customer's selections. Because the background screen is set back slightly behind the front window, it offers much more privacy for the user.

In slot machine applications as well as transactional machines such as ATM, the video must be controlled by the central on-board computer in a one-way communication method. The computer must be able to control the actions of the top-box display, but must not be able to receive transmission or data from the top-box for security reasons. This has been a difficult task to accomplish in the past for two reasons. The top-box display systems are equipped with two video output devices or monitors. Computers are able to output three separate video signals simultaneously, foreground 3D signal, background video signal, and the ATM transaction screen or Slot machine play screen. Available software and hardware requires that the decoding of the video signals be accomplished with the CPU of the computer. The software running in the Slot machine or ATM must meet government regulations and inspections to insure they are secure and that auxiliary equipment cannot affect the secured ATM or Game-play software. At the time of this writing, this could only be accomplished by a dual channel synchronized video card, or a stand-alone dual synchronized video delivery system, which at the time of this writing was not commercially available. A custom video card is required that contains two Mpeg-2 decoder chips and supporting circuitry to control frame synchronization, video blanking, and synchronized frame selection.

In a typical vending machine embodiment, the real image projection system preferably is integrated into the vending machine. In the case of a soft drink vending machine, for example, a small real image projection system preferably includes a LCD or CRT as an image source (although any image source can be used), a digital media player, and flash card for media storage. The real image projection system is capable of projecting floating video images out in front of the vending machine, such as, for example, of subjects relating to the machine, such as the various brands of soft drinks available. The device also can play floating 3D video advertising, and optionally is triggered by a proximity sensor, such as, for example, to change the content when someone walks up to the machine.

In the case of a vending machine, the electronic controls internal to the machine typically cannot support the video delivery, therefore a dual synchronized video delivery system must take its cues from the host machine electronics and independently run the appropriate videos in a self-contained system. This requires a custom interface that can monitor the host machine operation with electronic sensors and then run the corresponding media presentation on the display device. The majority of vending machines are electro-mechanically controlled, which requires a method of monitoring the movement of mechanical parts within the host machine. This is accomplished using a micro-controller or “PIC” chip with various inputs connected to sensors, which then evaluates the inputs from the sensors and outputs a control signal to a video display Mpeg decoder card. In the case of a real object projection system, the control signal is output to an indexer control card which then indexes the appropriate product into position for projection as a real image. A description of a typical indexer control mechanism is described in U.S. Pat. No. 6,612,701, the complete disclosure of which is hereby incorporated herein by reference in its entirety.

In a typical product or merchandising display embodiment, the real image projection system preferably is integrated into the product display. In the case of a cosmetic display, a series of sampler perfumes can be displayed in a product display and the real image of a perfume bottle can float over the product, as one example. The internal lighting and image rotation are controlled with a proximity sensor. In some cases, a multi-station turret can be incorporated, which allows numerous objects to be imaged in sequence, either randomly or controlled by a proximity sensor or customer selection. There are numerous applications of the invention, such as watch displays, where watches are displayed in a clear plastic tube on shelves on a store countertop. The real image display can be enclosed on the top of the display, projecting a real image of a real watch, floating overhead out in front of the display case as an attractor or to differentiate a brand.

In the case of a merchandising display, the same difficulties exist in interfacing to the host merchandising display as in the vending machines. The system requires a method to convert the customers interaction into a digital signal that will control the real image display. This can be accomplished using a similar Micro-controller as mentioned previously with input signals provided by proximity sensors or contact sensors under the products that are triggered by customer interaction, thus indexing the product into position for viewing the real image and starting the marketing presentation on the background monitor of the projection system.

The control of the real image display based on customer interaction is accomplished with several methods, based on the type of host machine in which it is integrated. One method of interaction is accomplished with a custom dual video card for a computer and “dll” software which can be controlled by the host machines software. The card consists of two Mpeg-2 decoders and various components for frame synchronization. It also has components to provide dual video output, controllable by an on-card controller by making function calls to the dll routines. These controls include screen blanking for smooth transitions between videos, frame synchronization control to maintain synchronization between the videos, and control over starting and stopping videos at the same frame number. These features are not available on standard dual monitor video cards.

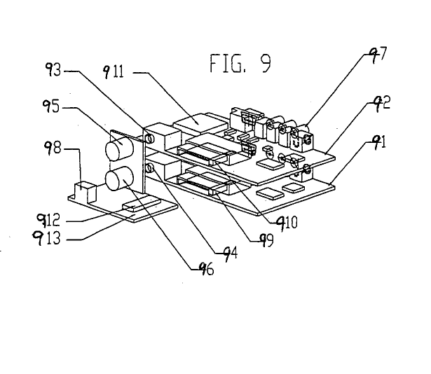

The second method of video output is using two single Mpeg decoder as a stand-alone component that has a flash card or compact memory card as a media storage source. Single channel devices are available commercially, but there are currently no dual channel cards or devices manufactured, since real image projection would be the only market for such a device. Creation of a dual channel video player is accomplished by incorporating two single channel cards into a control device and interfacing them with a micro-controller or “PIC” chip. The micro-controller will output control signals to the individual decoders simultaneously through the digital outputs of the chip. The inputs of the chip will interface with external control sensors or switches to activate features based on customer interaction. The control code to interpret the inputs and activate the appropriate outputs is controlled through a software application which is programmed into the micro-controller. Single Mpeg decoder boards using Infrared remote controls are commercially available, but no device is currently available to control the two infrared inputs simultaneously without a hand-held remote control. As shown in FIG. 9, the solution is to design a dual output Infrared transmitter that receives a signal from a micro-controller or “PIC” chip. The two single channel Mpeg decoder boards are positioned so that the Infrared receivers are aligned with the infrared transmitters of the interface device. The micro-controller is digitally controlled by a main computer and is interfaced only with the outputs of the computer and does not offer two-way communication, therefore enabling it's use in secured environments such as ATM's and slot machines.

In the case of an analog real image display, the device uses an actual object mounted inside the device, which then forms a real image of the object floating in space out in front of the display housing. The actual target object is mounted onto a motorized spindle shaft, and the object is lighted using LED's. In the case of a single product projection where the display does not have to index between several products, control is accomplished using a single micro-controller which can receive input from proximity sensors, contact sensors, and control buttons. The output will control the spindle rotation and lights to create 3D effects as customers interact. For systems requiring real image projection multiple products, an indexing device is incorporated which will index various objects into position which are then projected as real images. The indexing of product can be controlled with a timer routine coded into the micro-controller which sets the display time for each index based on a dip-switch setting which is connected to the micro-controller inputs. In the case of a product display where item such as perfume bottles are displayed, the display case can have contact sensors mounted under each bottle so that when a customer picks up a bottle, the display will immediately index to the appropriate product and display that product as a 3D real image. The physical actions of the indexer, rotating product motor, and lighting are controlled by the software code written and stored in the micro-controller, based on the input signals that the micro-controller receives.

### Slot Machine Applications

### EXAMPLES 1-3

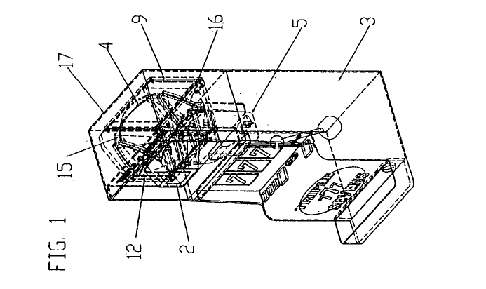

Referring now to FIG. 1, a typical slot machine (3) is shown with a housing (17) installed containing a “top-box” real image projection system (4). The real image projection system (4) has an image source (5), which in this case is a video or monitor that emits light from the screen, passes through the optical elements (15, 16) and then forms a real image (2) of the monitor screen floating out in space in front of the viewer. The system incorporates a background image source (9), which is visible through the window (12) behind the real image (2).

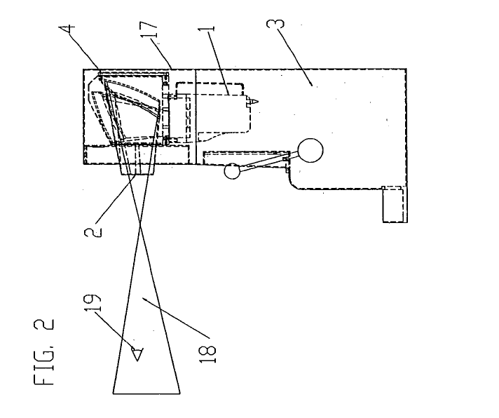

FIG. 2 shows a side view of the device described in FIG. 1. The real image projection system (4) contained in the top-box housing (17) projects a real image in space (2). The real image projection system (4) is positioned such that the angle of view (18) is compatible with the eyeball height (19) of the average viewers.

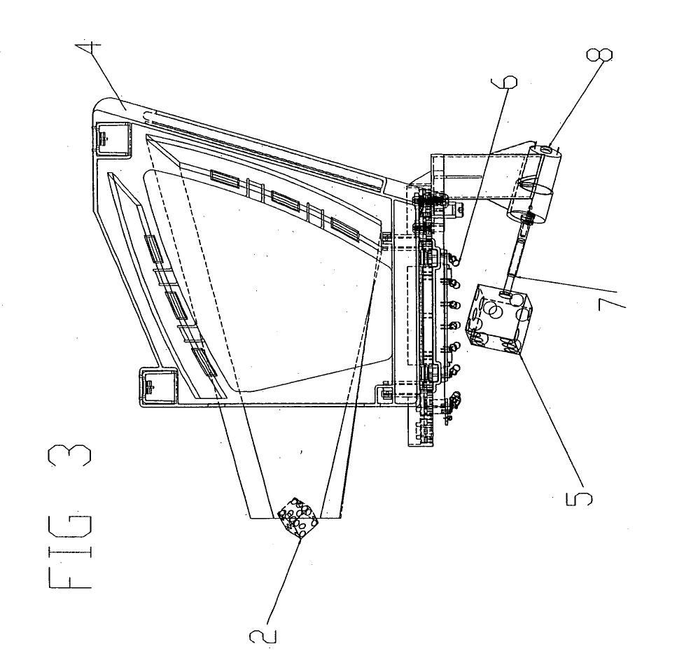

FIG. 3 shows an example of a typical dual aspheric real image projection system (4) with dice as the image source (5), a rotation mechanism including spindle (7) and stepping motor (8), and the internal lighting (6). The display forms a real image (2) of the image source (5) in space in front of the device. The image source rotation is performed by a stepping motor (8), which can then be controlled by the slot machine computer.

### ATM Applications

### EXAMPLES 4-6

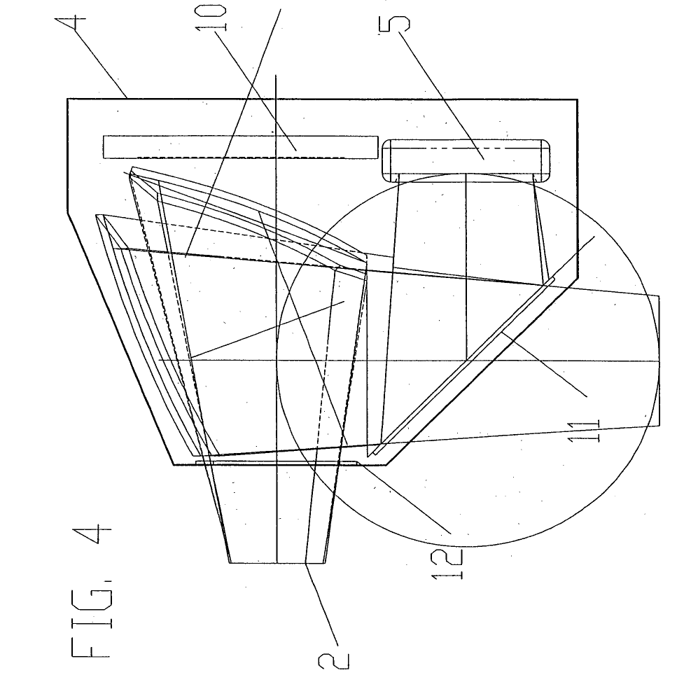

FIG. 4 shows an example of a typical dual aspheric real image display system (4) with a monitor as the image source (5). The image source in this example is a LCD panel (10), which strikes a fold mirror (11), redirecting the light from the image source into the projection system (4). The real image (2) is then redirected into space and formed out in front of the viewing window (12).

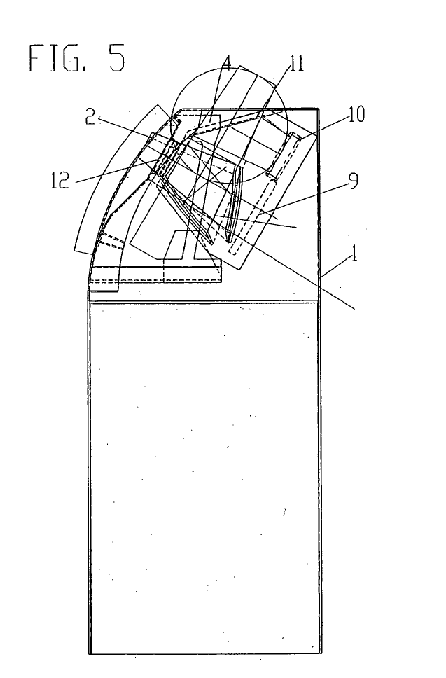

FIG. 5 shows an example of an ATM machine (1) with a real image projection system (4) of FIG. 3, incorporating an LCD panel as a background source (9) as a primary transaction screen. The image source in this example is a LCD panel (10), which strikes a fold mirror (11), redirecting the image into the optical system (4). The real image (2) is then redirected into space out in front of the viewing window (12).

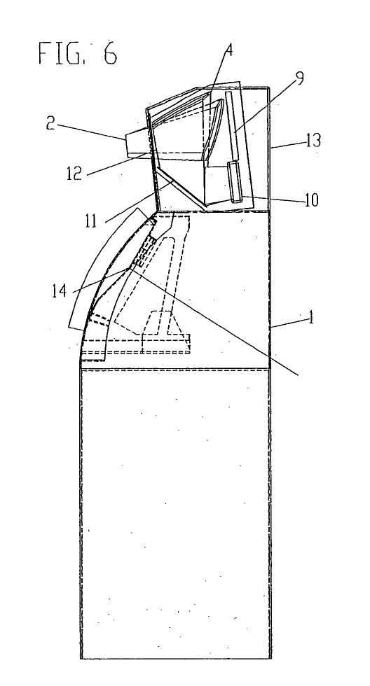

FIG. 6 shows a top-box (13) application of an ATM machine (1) whereby the real image (2) is separate from the transactional screen (14). The image source in this example is a LCD panel (10), which strikes a fold mirror (11), redirecting the image into the projection system (4). The real image (2) is then redirected into space out in front of the viewing window (12). An optional secondary LCD screen is used as a background source (9) and is visible through the window (12) behind the real image (2).

### Merchandising and Vending Machine Applications

### EXAMPLES 7-8

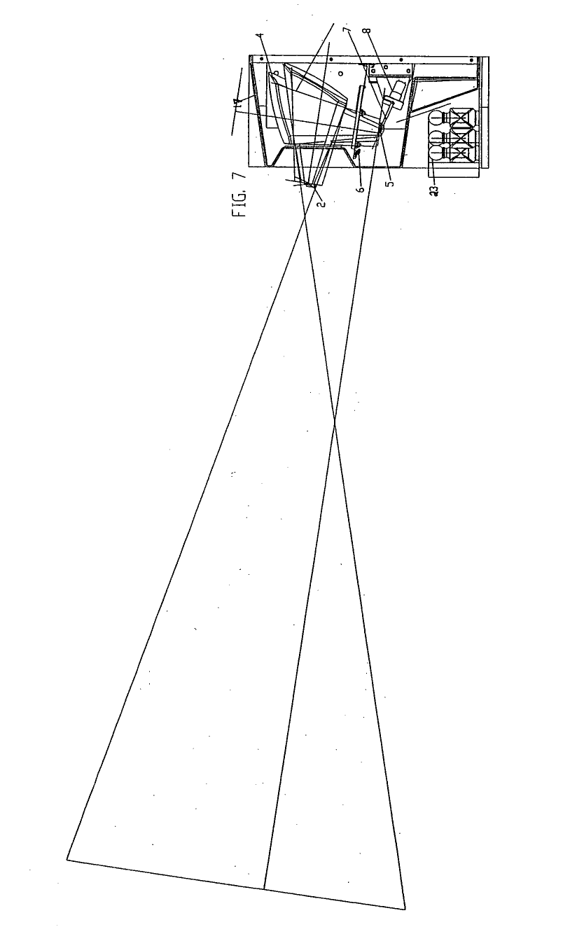

FIG. 7 shows a side view of a merchandising display wherein sampler perfume bottles (23) are displayed in an array for customer sampling. The real image projection system (4) contained in the upper portion of the housing (17) projects a rotating real image of a perfume bottle (2) in space. The actual image source (5) is a real perfume bottle, lighted by a bank of LED lamps, which serves as internal lighting (6) and is mounted to a motorized (8) rotating spindle (7).

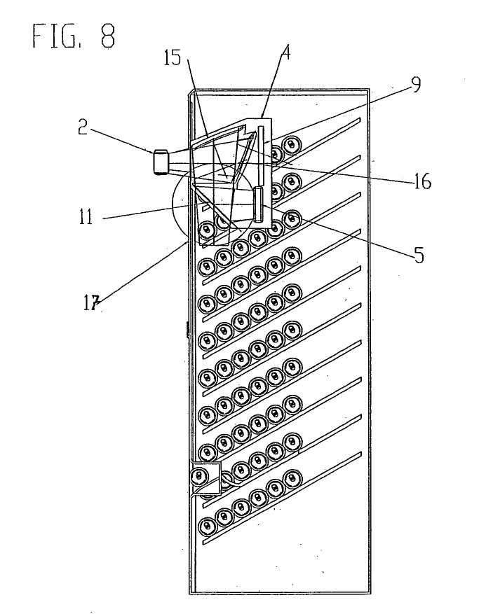

FIG. 8 shows a vending machine application wherein the real image projection system (4) is incorporated into the vending machine housing (17) to either enhance the operation and function of the machine or as an attractor. The real image (2) of the object is projected into space in front of the machine. The image source (5) is a LCD panel and emits light, reflecting off of a fold mirror (11), striking the upper aspheric mirror (optical element 15). It is then collimated, and strikes the lower aspheric mirror (optical element 16), reflecting as a converging beam to the focal point, forming the real image (2) in space. An LCD provides an optional background source (9) that is visible through the lower aspheric mirror (optical element 16), which preferably is optically coated with a beamsplitter coating or partially transmissive coating.

FIG. 9 shows a typical solution to the dual channel MPEG player with synchronized starting, stopping and frame selection (91, 92, 913). The device incorporates two Infrared controlled single MPEG Players (91, 92) which are positioned so that the infrared receiver lenses (93, 94) are aligned with the Infrared transmitter modules (95, 96 respectively) which are located on the custom interface printed circuit board (913). The Mpeg Players (91, 92) are equipped with Digital flash card holders (99, 910) which contain the foreground and background videos in Mpeg Format. Each player has a dedicated Mpeg Decoder chip (911) and video and audio outputs (97) for each monitor input. The Infrared transmitters (95, 96) are controlled by the outputs of a micro-controller (912) located on the custom interface board (913). The inputs of the micro-controller (112) receive digital instructions through a serial or USB interface port (98) on the custom interface board (913). Since only the inputs of the micro-controller (912) are connected to the interface port (98), two way communication is not possible and therefore meets the requirements of the government agencies in maintaining security of the host computer connected to the interface port. Other methods of interface are used when infrared receivers are not available, such as direct connection to the serial pin-outs of the Mpeg player.

The present invention further provides a real image projection device comprising a real image projection system, means for storing data, such as a computer or simply a microprocessor, and input means, such as a keyboard, but preferably a touch-screen display or interactive input device, for a viewer to enter data, such as an e-mail address. The real image projection system attracts the attention of viewers or potential customers, by projecting one or more images into a space near the real image projection device, giving the illusion that something exists at that point in space, when in reality it does not. In a preferred embodiment, the invention provides a relatively small kiosk presenting a moving image or video presentation, appearing as a 3-D image floating in viewer space, or in front of the kiosk. As a viewer approaches the floating 3-D image, an input device is provided, preferably a touch-screen display (e.g., optionally located under the real image window), for example, wherein an image of a keyboard is displayed to the viewer. The touch-screen display optionally displays advertising and/or prompts the viewer to enter the viewer's e-mail address to receive various free promotional items.

A typical e-mail register kiosk preferably includes a small footprint cabinet or enclosure, with a real image projection device installed inside, and a view window or aperture located at approximately eye level to a viewer standing in front of the cabinet. The real image projector preferably provides a floating foreground image, preferably generated from a CRT, and an optional virtual background image, preferably generated from a second CRT, LCD, or gas plasma display. The two monitors preferably are driven by a video signal from a computer located inside the enclosure. Input means, preferably a touch-screen LCD panel or CRT located below the real image window, is interfaced with a computer or microprocessor, preferably the same computer or microprocessor.

The computer that drives the three monitors should be capable of outputting one or two video NTSC signals, preferably in Mpeg-1 or Mpeg-2 formats. It also should include means for storing video files, preferably a hard drive. One example for outputting the required signals includes the use of a dual-channel Mpeg-2 decoder card, which is available commercially, plus a standard video card to supply a VGA signal. Optionally, some of the available VGA cards have composite outputs in addition to VGA. In cases where no background image is required or desired, one of these cards optionally is used to output a single Mpeg composite signal to the monitor, and a VGA signal to the touch-screen display. However, one of ordinary skill in the art will understand that many hardware solutions are possible, depending upon the specific requirements of the system to be deployed.

The software for operating the system preferably accomplishes several functions. It should be able to interface with the user and provide a user-friendly method of entering e-mail addresses. One such method is to provide a touch-screen image of a keyboard. Preferably, the method of entry of an e-mail address is both simple and fun. The computer also should be able to output a video signal, preferably in Mpeg-1 or Mpeg-2 format, or other video format, preferably while simultaneously operating the virtual keyboard on the touch-screen display. This can be accomplished with a software decoder outputting through the composite port of a TV-Video card, as will be understood by one of ordinary skill in the art. In cases where a synchronized foreground and background image are required, the optimum solution is the use of a dual Mpeg decoder card.

Preferably the computer automatically starts on power-up of the system, and should be operational without any manual setup. For example, in cases where a Windows based operating system is used, one or more applets should be written to automatically load and run the various programs required, and perform the necessary functions, such as storing e-mail addresses in a database, and for remote access from a central location.

The computer optionally includes a modem or network card, providing for e-mail addresses to be transferred to a central remote database. The modem system may be any form such as, but not limited to, DSL, cable, T-1, T-3, telephone, or any other form capable of data transmission and receipt. The modem preferably is connected to a broadband service, such as cable modem or DSL, however, standard 56 k modem service will suffice, for example, if the video files are not installed or updated from a remote location. In cases where the e-mail register kiosk systems are installed in a chain of restaurants or commercial facilities, the video content or 3-D graphic content optionally is uploaded to individual locations from a remote central location on a regular basis. The e-mail addresses accumulated preferably also are downloaded to the central database.

While the preferred embodiment comprises a computer for processing and storage of e-mail addresses, it is emphasized that a computer is not required. Alternatively, a simple microprocessor or memory unit is used for storage and retrieval of e-mail addresses and/or other data, as will be clear to one of ordinary skill in the art.

### E-mail Kiosk Examples

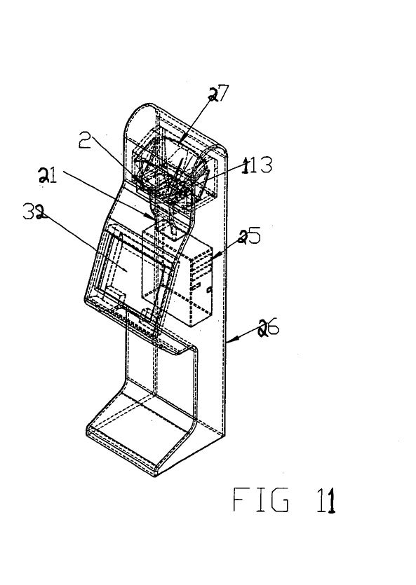

Referring now to FIG. 11, an embodiment of an e-mail register kiosk including a real image projection system is shown. The unit consists of a kiosk housing (26), preferably containing all of the system components. The real image projection system containing the imaging optics (27) is positioned so that the real image (2) floats out in front of the kiosk (26) in viewer space. The image source, preferably a 3-D target monitor (21) is located inside the kiosk (26). Light emitted from the monitor screen (1) is collected by the real imaging optical system (27) and is then projected through the image window (113), forming a real image (2) in viewer space in front of the window (113). A second monitor (32) preferably is positioned at approximately waist level for viewer input. The second monitor preferably is a touch-screen (33) input device, but optionally is any suitable input device. Both monitors (1,32) preferably are connected to a control device, such as a microprocessor or computer (25). The computer outputs video to the real image projection system monitor (1), while simultaneously interfacing with the viewer through the touch-screen display (33).

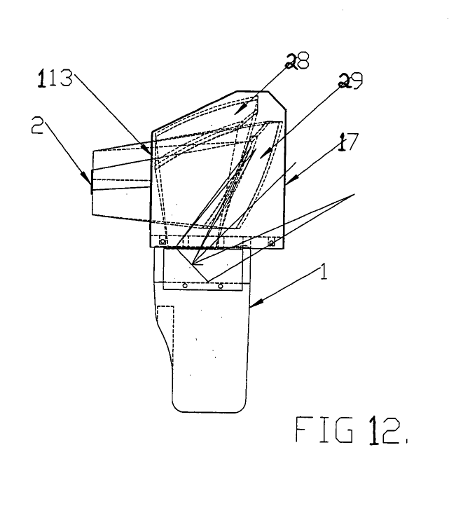

FIG. 12 depicts an alternative embodiment of the e-mail register kiosk of the present invention, including a typical real image projection system comprising a dual curved optic system using two curved reflectors (28,29) mounted into a housing (17), with a CRT (1) as a target or image source. The optical reflectors (28,29) gather the light beams emanating from the CRT (1), and refocus it into a converging beam, passing through the window opening (113) and forming a real image (2) in viewer space outside of the housing (17).

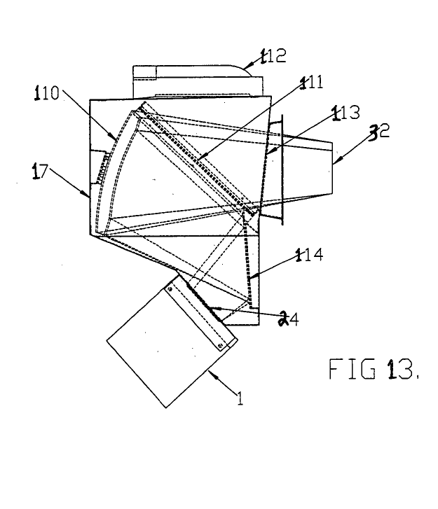

FIG. 13 depicts an alternative embodiment of the e-mail register kiosk of the present invention, including a typical real image projection system comprising a tilted off-axis single curved reflector (110), a fold mirror (114) to redirect the input light beam from the monitor (1) or image source located at the focal point (24) of the system. A secondary monitor (32) optionally is used in conjunction with a beamsplitter (111) to create a virtual image floating just inside the window opening (113), visible behind the floating real image (2). This system includes two video inputs from the e-mail kiosk computer, when incorporating a background display.

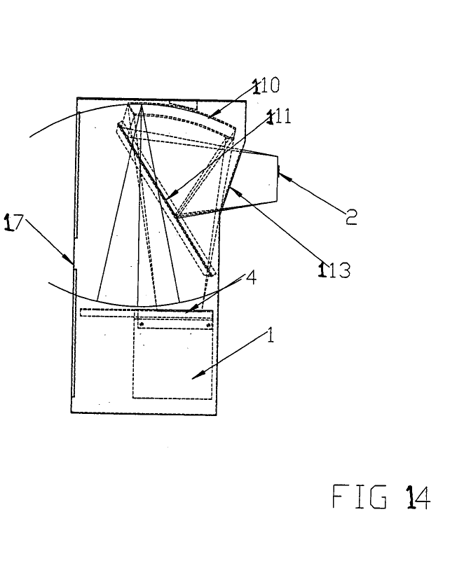

FIG. 14 depicts an alternative embodiment of the e-mail register kiosk of the present invention, including a typical real image projection system comprising a tilted off-axis curved reflector (110). In this configuration, the diverging light beam from the monitor or real image source, passes through the beamsplitter (111), striking the tilted curved reflector (110). The light is then reflected as a converging light beam and reflects off of the beamsplitter (111), passing through the window aperture (113) and forming a real image (2) in viewer space. This particular system has less light transmission than the system shown in FIG. 3, but is acceptable for use in the e-mail register kiosk.

There are several business models in which the e-mail register kiosk systems can be used. One example of such a business model is to contract with an establishment, such as a hotel chain, deploying a system in each of the chain's hotels. The cost of the systems and installation preferably is shared with the hotel chain, and, for example, each hotel preferably would pay a monthly service fee. The hotel chain preferably purchases services, such as, for example, video production of new advertisements, for the real image display on a regular basis, and accumulation and maintenance of a database of e-mail addresses or other information. The individual hotels preferably would then review their bookings and select specific dates, for example, when they have high vacancy rates. Normally, the hotel would be forced to offer the vacancies to a consolidator on consignment, typically at a greatly discounted rate. Alternatively, however, when using the present system, the hotel notifies the database administrator that it wishes to fill a certain number of vacancies on specific dates, at a certain discounted price, and the administrator performs a mass e-mailing to individuals who entered their e-mail addresses into the database. This service optionally is offered on a fee basis or on a commission basis.

In another business model example, the e-mail register kiosk is placed in an individual hotel or multiple hotels in a hotel chain, or other hospitality establishment, to gather e-mail addresses of people staying at the hotel, and optionally, for example, offering to notify them of special deals and vacation packages. For example, when the hotel has a weekend with a high rate of vacancies, e-mails are sent out offering a special rate for that weekend, including, for example, free breakfast or other promotional offers. Hotels can then directly sell their vacancies, rather than consign the vacant rooms to consolidators at a discount. The real image display not only attracts viewers or potential customers and prompts them to enter e-mail addresses, but also can advertise hotel services and events. In addition, for example, the kiosk optionally includes interactive features, for example, providing many of the services and functions of a concierge. For example, the same interactive interface between the touch-screen and the real image display optionally allows hotels guests to scroll through various hotel activities that are available, thereby serving as an electronic concierge. By entering their e-mail address and room number, the guest could, for example, directly book activities and tours, billing them to their room.

In another business model example, the e-mail register kiosk is placed in an individual restaurant or multiple restaurants in a chain (e.g., “fast-food” franchise), or other food service establishment, wherein the kiosk plays, for example, a 3-D video of an advertisement for the restaurant and projects a floating real image of a trademark character prompting the viewer to enter the viewer's e-mail address in return for free coupons, for example. Optionally, viewers who enter their e-mail address periodically receive e-mail providing coupons, such as for restaurant discounts or free items. The e-mail coupons optionally are provided as redeemable only at a specific restaurant within a chain.

The e-mail register optionally offers other services as well. For example, in the case of a restaurant chain, the touch-screen display optionally directly controls the 3-D real image and is entirely interactive. For example, the menu is presented by pressing a menu button on the touch-screen, and the various food items are shown as a floating 3-D real image rotating in space in front of the viewer.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A real image projection apparatus, comprising:
a real image projection system for projecting a real image from one or more sources that transmit, reflect or emit light;
operatively connected to an e-mail capture system for establishing a database of e-mail addresses entered by viewers of said real image; or
operatively connected through a secure link to a gaming or slot machine, ATM machine, vending machine or any point of sale apparatus that includes an on-board computer or CPU for controlling operation thereof, such that said on-board computer or CPU provides input to said real image projection system, but does not receive input or data from said real image projection system or any other external source.

2. The apparatus of claim 1, wherein said real image projection system comprises two curved reflectors, of which at least one is aspherical in surface of revolution.

3. The apparatus of claim 1, wherein said real image projection system comprises two curved reflectors, of which at least one is parabolic in surface of revolution.

4. The apparatus of claim 1, wherein said real image projection system comprises one curved reflector tilted with the reflector axis between 12 degrees and 18 degrees relative to the system viewing axis, and wherein the real imaging light beam does not reflect off the surface of a beamsplitter.

5. The apparatus of claim 1, wherein said real image projection system comprises an on-axis spherical mirror, beamsplitter and circular polarizing window.

6. The apparatus of claim 1, wherein said real image projection system comprises at least one video input device, video display device, LCD, CRT, illuminated static-image panel or a real object source as input.

7. The apparatus of claim 1, wherein said real image projection system comprises a real object or a video input device as an image source, and a video signal is provided by said slot or gaming machine and synchronized to enhance game play content.

8. The apparatus of claim 7, wherein the video signal source and content are incorporated into the real image projection system and manipulated by a control signal output from the slot or gaming machine internal computer.

9. The apparatus of claim 7, wherein the video signal source and content are incorporated into the real image projection system and operate independently of the slot or gaming machine electronics.

10. The apparatus of claim 7, wherein said real image projection system comprises a real object or objects as an image source, and the real object(s) is controlled and manipulated from the slot or gaming machine internal computer.

11. The apparatus of claim 7, wherein said real image projection system comprises a real object or objects as an image source, and the real object(s) operates independently of the gaming machine and functions as an attractor of users of said gaming machine.

12. The apparatus of claim 1, wherein said real image projection system comprises a real object or video input device as an input source, and a video signal source is provided by the ATM machine electronics and synchronized to enhance the ATM user experience.

13. The apparatus of claim 12, wherein the video signal source and content are incorporated into the projection device and manipulated by a control signal output from the ATM machine internal computer, or controlled by a proximity sensor.

14. The apparatus of claim 12, wherein the video signal source and content are incorporated into the projection device and operate independent of the ATM machine electronics.

15. The apparatus of claim 12, wherein said real image projection system comprises a background video that is controlled by the ATM internal computer, displaying the ATM graphics for user interface of ATM functions, while simultaneously displaying the real image floating in front of said background image.

16. The apparatus of claim 12, wherein said real image projection system comprises a real object as an image source, and image rotation and lighting are controlled by the ATM internal computer or a proximity sensor.

17. The apparatus of claim 1, wherein said real image projection system comprises a video input device, and the video signal source is provided by the vending machine electronics, or a real object as input source.

18. The apparatus of claim 17, wherein the video signal source and content are incorporated into the projection device and manipulated by a control signal output from the vending machine internal computer, or controlled by a proximity sensor.

19. The apparatus of claim 17, wherein the video signal source and content are incorporated into the projection device and operate independent of the vending machine electronics.

20. The apparatus of claim 17, wherein the image source is a real object and control of that object operates independent of the vending machine electronics.

21. The apparatus of claim 17, wherein the image source is a real object and the object is controlled by the vending machine electronics or a proximity sensor.

22. The apparatus of claim 1, wherein said real image projection system comprises a real object as an input source, or a video input source, and is used in a point of purchase merchandising display.

23. The apparatus of claim 22, wherein more than one image source is mounted on a turret assembly and indexed into position, being controlled by customer selection.

24. The apparatus of claim 22, wherein the video image source is controlled by a proximity sensor, or switch device activated by touching the display product, or operates independently of the display.

25. The apparatus of claim 1, wherein said source comprises a real object, a video monitor, computer monitor, or projection screen, or other source that transmits, reflects or emits light.

26. The apparatus of claim 25, wherein said real image projection system comprises an optical system, which inputs diverging light from said source, refocuses said diverging light into a converging beam, and then forms a real image of said source in a space in front of said real image projection apparatus.

27. The apparatus of claim 26, wherein said source comprises at least one target monitor and said real image projection system further comprises means for providing at least one electronic video signal to said at least one target monitor.

28. The apparatus of claim 27, wherein said video signal is provided by a DVD player, laser disk player, computer, and/or other video means, interfaced with a computer and/or computer driven controller.

29. The apparatus of claim 28, wherein said computer and/or computer driven controller has one or more VGA outputs and/or video outputs.

30. The apparatus of claim 29, wherein said one or more video outputs are NTSC, PAL, S-Video, composite, RGB, and/or other format compatible with said real image projection system.

31. The apparatus of claim 29, wherein said one or more video outputs are Mpeg-1, Mpeg-2, or AVI format, VGA computer generated graphics, or other video output from stored data.

32. The apparatus of claim 28, wherein said computer and/or computer driven controller is built into a video output device, or a video device including an RS-232 port or serial port or other connector for providing communication with an external controller or computer.

33. The apparatus of claim 27, wherein at least two video files, one being a foreground video and another being a background video, are stored on a hard drive or other digital storage device, and outputted to two video monitors as video signals synchronized with each other, thus keeping said background video synchronized with said foreground video.

34. The apparatus of claim 1, further comprising computer-controlled means for direct control and/or manipulation of said real image projection system.

35. The apparatus of claim 34, wherein said computer-controlled means comprises a computer or microprocessor, and further comprising software for control and/or manipulation of said real image projection system.

36. The apparatus of claim 34, wherein said control and/or manipulation of said real image projection system includes product selection or selection of items from a screen list or a virtual catalog display.

37. The apparatus of claim 34, wherein said manipulation of said real image projection system includes control of said real image or selection of different images or video tracks displayed by said real image projection system.

38. The apparatus of claim 34, wherein said source is a 3D solid model with photo-matted surfaces, outputted to a target monitor and controlled through a software program.

39. The apparatus of claim 35, wherein said software comprises a commercial software package, and/or one or more custom applets, or other custom control software.

40. The apparatus of claim 39, wherein said software includes an e-mail register applet to allow said viewer to enter one or more e-mail addresses into a database, through an input device.

41. The apparatus of claim 39, wherein said software monitors inputs from said viewer and controls and/or manipulates said real image to create an interactive experience.

42. The apparatus of claim 39, wherein said software includes an applet to control a video output or select and play a specific video file from a series of video files.

43. The apparatus of claim 32, wherein said selection of said video file is based upon said viewer's input to said input device.

44. The apparatus of claim 35, wherein two video signals are played in synchronization, one foreground real image and a second background image.

45. The apparatus of claim 44, wherein said control software maintains synchronization of said video files while playing, and/or selects video files in pairs of foreground and corresponding background.

46. A method for promoting goods or services, comprising the steps of:
deploying in an establishment the real image projection apparatus of claim 1 operatively connected to a gaming or slot machine, ATM machine, vending machine or any point of sale apparatus; and
promoting said goods or services by directing promotions to users of said gaming or slot machine, ATM machine, vending machine or point of sale apparatus.

47. The method of claim 46, wherein real image projection apparatus comprises a dual channel synchronized video card, or a stand-alone dual synchronized video delivery system.

48. The apparatus of claim 1, wherein said e-mail capture system comprises:
a computer, microprocessor device, memory, or other means for storing said database; and
a keyboard, touch-screen device, or pointing device and display monitor, or other input means, arranged for a viewer of said real image to enter one or more e-mail addresses into said database.

49. The apparatus of claim 48, wherein said input means comprises an interactive touch screen CRT or LCD monitor, or a CRT or LCD monitor and keyboard or pointing device.

50. The apparatus of claim 48, further comprising a modem or network card, or other means for remote access of said database, and/or for transferring video or other files to or from a remote location, and/or general communication with a remote location.

51. The apparatus of claim 48, wherein said image source comprises a real object, a video monitor, computer monitor, or projection screen, or other source that transmits, reflects or emits light.

52. The apparatus of claim 51, wherein said real image projection system comprises an optical system, which inputs diverging light from said source, refocuses said diverging light into a converging beam, and then forms a real image of said source in a space in front of said real image projection apparatus.

53. The apparatus of claim 52, wherein said source comprises at least one target monitor and said real image projection system further comprises means for providing at least one electronic video signal to said at least one target monitor.

54. The apparatus of claim 53, wherein said video signal is provided by a DVD player, laser disk player, computer, and/or other video means, interfaced with a computer and/or computer driven controller.

55. The apparatus of claim 54, wherein said computer and/or computer driven controller has one or more VGA outputs and/or video outputs.

56. The apparatus of claim 55, wherein said one or more video outputs are NTSC, PAL, S-Video, composite, RGB, and/or other format compatible with said real image projection system.

57. The apparatus of claim 55, wherein said one or more video outputs are Mpeg-1, Mpeg-2, or AVI format, or other video output from stored data.

58. The apparatus of claim 54, wherein said computer and/or computer driven controller is built into a video output device, or a video device including an RS-232 port or serial port or other connector for providing communication with an external controller or computer.

59. The apparatus of claim 53, wherein at least two video files, one being a foreground video and another being a background video, are stored on a hard drive or other digital storage device, and outputted to two video monitors as video signals synchronized with each other, thus keeping said background video synchronized with said foreground video.

60. The apparatus of claim 48, further comprising computer-controlled means for direct control and/or manipulation of said real image projection system and/or said database.

61. The apparatus of claim 60, wherein said computer-controlled means comprises a computer or microprocessor, and further comprising software for control and/or manipulation of said real image projection system and/or said database.

62. The apparatus of claim 60, wherein said control and/or manipulation of said real image projection system includes product selection or selection of items from a screen list or a virtual catalog display.

63. The apparatus of claim 60, wherein said manipulation of said real image projection system includes control of said real image or selection of different images or video tracks displayed by said real image projection system.

64. The apparatus of claim 60, wherein said source is a 3-D solid model with photo-matted surfaces, outputted to a target monitor and controlled through a software program.

65. The apparatus of claim 61, wherein said software comprises a commercial software package, and/or one or more custom applets, or other custom control software.

66. The apparatus of claim 65, wherein said software includes an e-mail register applet to allow said viewer to enter one or more e-mail addresses into said database, through said input device.

67. The apparatus of claim 65, wherein said software monitors inputs from said viewer and controls and/or manipulates said real image to create an interactive experience.

68. The apparatus of claim 65, wherein said software includes an applet to control a video output or select and play a specific video file from a series of video files.

69. The apparatus of claim 68, wherein said selection of said video file is based upon said viewer's input to said input device.

70. The apparatus of claim 61, wherein two video signals are played in synchronization, one foreground real image and a second background image.

71. The apparatus of claim 70, wherein said control software maintains synchronization of said video files while playing, and/or selects video files in pairs of foreground and corresponding background.

72. The apparatus of claim 61, wherein said e-mail addresses are stored in a database file, and said software has sufficient error-trapping routines so as to create a substantially stable and reliable platform.

73. The apparatus of claim 61, wherein said database is uploaded to a remote location.

74. The apparatus of claim 73, wherein said upload is accomplished through a subroutine, which automatically transmits said data at preselected times, or accepts instructions from a remote location to upload said data.

75. A method for promoting goods or services, comprising the steps of:
deploying in an establishment the real image projection apparatus of claim 1 comprising the e-mail capture system;
prompting viewers of said real image to enter one or more e-mail addresses;
establishing a database of said e-mail addresses; and
promoting said goods or services by directing promotions to selected e-mail addresses in said database.

76. The method of claim 75, wherein real image projection apparatus comprises a dual channel synchronized video card, or a stand-alone dual synchronized video delivery system.
